(19) United States
(12) Patent Application Publication
(10) Pub. No.: US 2016/0301698 A1
(43) Pub. Date: Oct. 13, 2016

(54) IN-VEHICLE AUTHORIZATION FOR AUTONOMOUS VEHICLES

(71) Applicant: Hill-Rom Services, Inc., (US)

(72) Inventors: Mika KATARA, Tampere, LS (FI); Jiang CHENG, Shaanxi (CN); Alexander MALTSEV, Nizhny Novgorod (RU); Bernhard RAAF, Neuried, BY (DE); Michael R. TIERNEY, Munich, BY (DE)

(21) Appl. No.: 14/368,347

(22) PCT Filed: Dec. 23, 2013
(86) PCT No.: PCT/US2013/077590

§ 371 Date: Jun. 24, 2014

(51) Int. Cl. H04L 29/06; G06K 19/06; G06F 17/30; G07B 13/04

(52) U.S. Cl. CPC H04L 63/102; G07B 13/04; G06K 19/06037; G06F 17/30879; G06Q 50/30

(57) ABSTRACT

Technologies for authorizing a passenger of an autonomous vehicle include determining a passenger authorization policy based on a request for a taxi service and determining whether a passenger is authorized for the taxi service based on the passenger authorization policy. The passenger authorization policy may include a set of rules for authorizing a passenger based on the request for the taxi service and/or a global authorization policy. For example, the passenger may be authorized based on the identity of the passenger, the number of passengers, the age of the passenger, an authentication token, and/or other methodologies. The passenger authorization policy may be generated by the autonomous vehicle in response to the request for a taxi service or received from a passenger authorization management server as part of the request for the taxi service.

### BACKGROUND

Smart traffic and autonomous vehicles are anticipated to revolutionize transportation in the future. Autonomous vehicles can be generally defined as vehicles capable of vehicular navigation without human input. In some cases, the autonomous vehicle may have no human driver. In other implementations, a human driver may be present but provide no active input during autonomous vehicular navigation. Autonomous vehicles may use various technologies to navigate the roadway including, for example, global positioning system (GPS), radar, computer vision, and other technologies capable of sensing the environment of the autonomous vehicle. In some implementations, the roadway itself may provide further information to the autonomous vehicle to facilitate the autonomous vehicular navigation.

One predicted use of autonomous vehicles is the implementation of autonomous taxi service. While the technological challenges of autonomous navigation are quickly being overcome, autonomous taxi service provides additional challenges due to the reliance on the human driver in traditional taxi services. In a standard taxi service, the human driver is relied upon to make various decisions regarding the taxi service and passengers based on a wide range of information available to the human driver. For example, the human driver may be expected to ensure the passengers are the correct passengers, have properly paid for the taxi service, and/or have authority to modify the requested service as needed. In an autonomous taxi service, a human driver is typically not present to make such determinations.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for passenger authorization for an autonomous vehicle;

FIG. 2 is a simplified block diagram of at least one embodiment of an in-vehicle passenger authorization system of an autonomous vehicle of the system of FIG. 1;

FIG. 3 is a simplified block diagram of at least one embodiment of a passenger authorization management server of the system of FIG. 1;

FIG. 4 is a simplified block diagram of at least one embodiment of an environment of the in-vehicle passenger authorization system of FIG. 2;

FIG. 5 is a simplified block diagram of at least one embodiment of an environment of the passenger authorization management server of FIG. 3;

FIG. 6 is a simplified flow diagram of at least one embodiment of a method for responding to a request for taxi service that may be executed by the passenger authorization management server of FIG. 3;

FIG. 7 is a simplified flow diagram of at least one embodiment of a method for responding to a request for taxi service that may be executed by the in-vehicle passenger authorization system of FIG. 2; and

FIGS. 8 and 9 are simplified flow diagrams of at least one embodiment of a method for authorizing a passenger of an autonomous vehicle that may be executed by the in-vehicle passenger authorization system of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

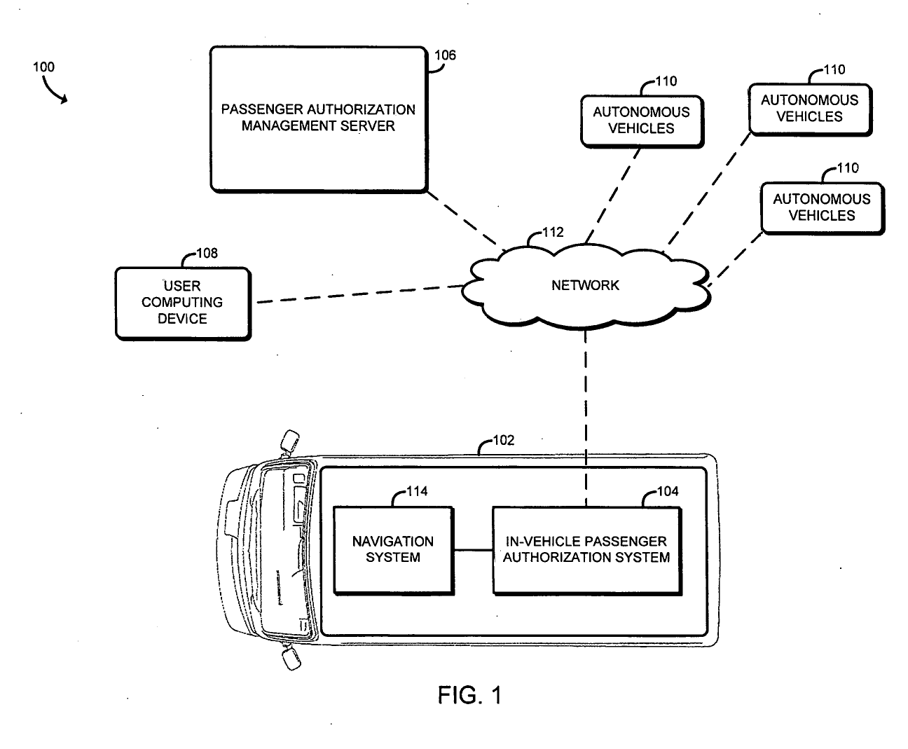

Referring now to FIG. 1, an illustrative system 100 for authorizing a passenger of an autonomous vehicle 102 includes an in-vehicle passenger authorization system 104 located in the autonomous vehicle 102, a passenger authorization management server 106, and a user computing device 108, which may communicate with each other over a network 112. In the illustrative embodiment, the passenger authorization management server 106 manages taxi service provided by a fleet of autonomous vehicles including the autonomous vehicle 102 and other autonomous vehicles 110. In use, a user of the user computing device 108 may communicate with the passenger authorization management server 106 (or directly with the in-vehicle passenger authorization system 104 in some embodiments) to request a taxi service by the autonomous vehicle 102. The user's request for taxi service may include information relating to the requested taxi service such as, for example, the number of passengers, identification of the passengers, origination and destination locations, billing information, and/or other information. The passenger authorization management server 106 generates a passenger authorization policy based on the user's request for taxi service. The passenger authorization policy includes a set of rules and/or data usable by the in-vehicle passenger authorization system 104 to authorize or verify passengers according to the requested taxi service. For example, if the request for taxi service identifies three passengers, two adults and a child, the passenger authorization policy may include a rule requiring the in-vehicle passenger authorization system 104 to verify a total of three passengers, of which two are adults and one is a child. Of course, as discussed in more detail below, the passenger authorization policy may include additional or other rules or data (e.g., images of authorized passengers) usable by the in-vehicle passenger authorization system 104 to authorize or verify the passengers. The passenger authorization management server 106 subsequently transmits the request for taxi service, including the passenger authorization policy, to the in-vehicle passenger authorization system 104 of the selected autonomous vehicle 102.

In response to receiving the request for taxi service, the autonomous vehicle 102 navigates to the origination location, if required, to pick-up the user requesting taxi service. As discussed below, the autonomous vehicle 102 performs such navigation without the assistance of a driver using a navigation system 114 of the autonomous vehicle 102. Upon arriving at the origination location, the user and company requesting the taxi service, or other unauthorized individuals, may then enter the autonomous vehicle 102 as passengers. It should be appreciated that because the autonomous vehicle 102 is driverless, independent verification of the passengers according to the request for taxi service is required. As such, the in-vehicle passenger authorization system 104 authorizes the passengers of the autonomous vehicle 102 based on the passenger authorization policy. To do so, the in-vehicle passenger authorization system 104 may verify the number of passengers, the identification of the passengers, the age of the passengers, authorization tokens provided by the passengers, and/or other characteristics or traits of the passengers based on the policy rules defined by the passenger authorization policy. For example, in one embodiment, the in-vehicle passenger authorization system 104 may capture an image of the passenger and compare it to an image of an authorized passenger included in the passenger authorization policy. If the passengers are deemed to not be authorized, the taxi service is denied for those passengers. In some embodiments, however, a taxi service for unauthorized passengers may be allowed in those situations in which an emergency situation is occurring. Regardless, if the passengers are authorized, the autonomous vehicle 102 navigates to the requested destination location. In some embodiments, the passenger authorization policy may provide additional rules or data for authorizing requests from the passenger during navigation to the destination location (e.g., whether the passenger is allowed to alter the destination or halt the autonomous vehicle).

The autonomous vehicle 102 may be embodied as any type of autonomous or “driver-less” vehicle capable of transporting passengers. In the illustrative embodiment, the autonomous vehicle 102 is configured to provide taxi service to requesting users, but may be configured for other purposes that require the transportation of individuals in other embodiments. For example, the autonomous vehicle 102 may be embodied as a company vehicle for transporting people across company grounds (e.g., from one building to another). Regardless, to ensure the present passengers are authorized for the taxi service, the in-vehicle passenger authorization system 104 authorizes or validates the passengers prior to navigation as discussed briefly above.

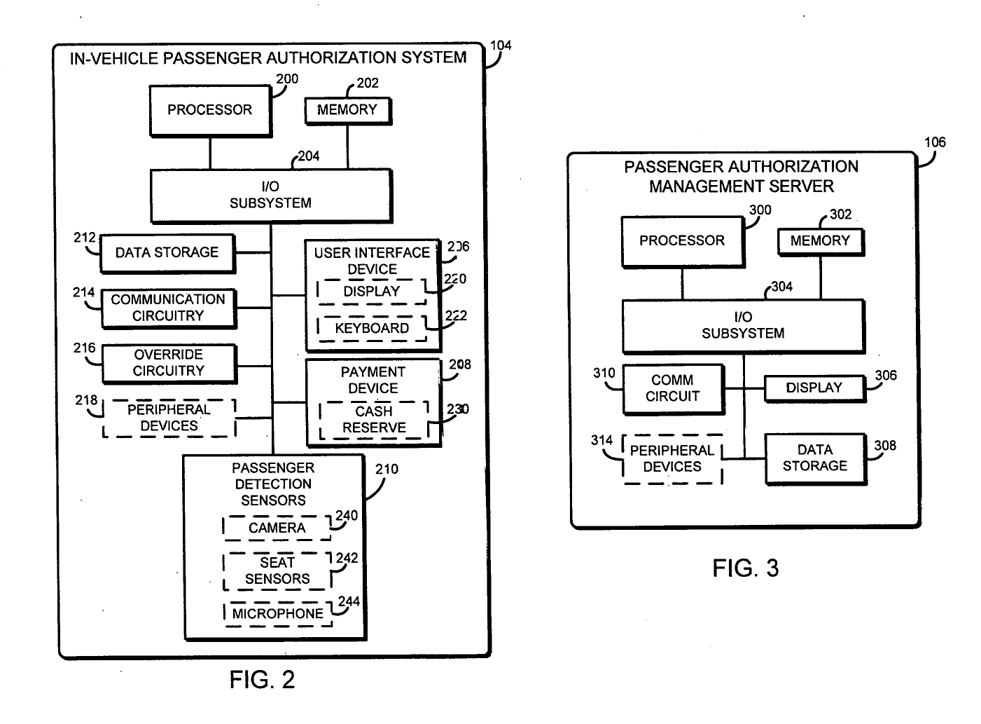

The in-vehicle passenger authorization system 104 may be embodied as any type of in-vehicle computing device or system capable of authorizing passengers and performing the functions described herein. As shown in FIG. 2, the illustrative in-vehicle passenger authorization system 104 includes a processor 200, memory 202, an I/O subsystem 204, a user interface device 206, a payment device 208, one or more passenger detection sensors 210, a data storage 212, communication circuitry 214, and, in some embodiments, override circuitry 216, Of course, the in-vehicle passenger authorization system 104 may include other or additional components, such as those commonly found in an in-vehicle computing system or other computing device (e.g., various input/output devices), in other embodiments. Additionally, in some embodiments, one or more of the illustrative components may be incorporated in, or otherwise form a portion of, another component. For example, the memory 202, or portions thereof, may be incorporated in the processor 200 in some embodiments.

The processor 200 may be embodied as any type of processor capable of performing the functions described herein. For example, the processor 200 may be embodied as a single or multi-core processor(s), digital signal processor, microcontroller, or other processor or processing/controlling circuit. Similarly, the memory 202 may be embodied as any type of volatile or non-volatile memory or data storage capable of performing the functions described herein. In operation, the memory 202 may store various data and software used during operation of the in-vehicle passenger authorization system 104 such as operating systems, applications, programs, libraries, and drivers. The memory 202 is communicatively coupled to the processor 200 via the I/O subsystem 204, which may be embodied as circuitry and/or components to facilitate input/output operations with the processor 200, the memory 202, and other components of the in-vehicle passenger authorization system 104. For example, the I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 200, the memory 202, and other components of the in-vehicle passenger authorization system 104, on a single integrated circuit chip.

The user interface device 206 may be embodied as any device or mechanism usable by a passenger to interact with the in-vehicle passenger authorization system 104. For example, the user may be requested to supply various data, such as the passenger's name or an authorization token (e.g., a personal identification number or password), to authenticate themselves to the in-vehicle passenger authorization system 104 as discussed in more detail below. To facilitate such interaction, the user interface device 206 may include various peripheral devices such as a display 220 and/or keyboard 222. The display 220 of the user interface device 206 may be embodied as any type of display on which information may be displayed to a passenger of the in-vehicle passenger authorization system 104. For example, the display 220 may be embodied as, or otherwise use, any suitable display technology including, for example, a liquid crystal display (LCD), a light emitting diode (LED) display, a cathode ray tube (CRT) display, a plasma display, and/or other display usable in a mobile computing device. Additionally, in some embodiments, the display 220 may be embodied as a touchscreen display and include an associated touchscreen sensor (not shown) to receive tactile input and data entry from the user. Similarly, the keyboard 222 may be embodied as any type of keyboard device usable by the passenger to supply information to the in-vehicle passenger authorization system 104. The keyboard 222 may be a physical keyboard or, in embodiments in which the display 220 is embodied as a touchscreen display, the keyboard 222 may be embodied as a virtual keyboard displayed on the display 220. Of course, the user interface device 206 may include additional or other devices or modalities to facilitate the supply of information to the in-vehicle passenger authorization system 104 by the passenger.

The payment device 208 may be embodied as any device or collection of devices capable of facilitating payment for the taxi service by a passenger. That is, in some implementations, the user requesting the taxi service may make payment through the passenger authorization management server 106 (e.g., via credit card). Alternatively, the user requesting taxi service may make payment directly at the autonomous vehicle 102. To support such local payment for the taxi service, the payment device 208 may include various devices capable of receiving payment such as a credit card scanner, a cash drop box, a coin machine, or other payment device. In some embodiments, local payment of the taxi service may be completed via the user interface device 206 (e.g., the user may make payment directly to the passenger authorization management server 106 via the user interface device 206). Depending on the particular type of payment devices 208 included in the in-vehicle passenger authorization system 104, the payment device 208 may include a cash reserve 230 for providing physical change to a passenger. However, in some embodiments, the payment device 208 is configured to provide no change, such that exact fare payment is required or overpayment is forfeited by the passenger to increase the overall security of the autonomous vehicle 102.

The passenger detection sensors 210 may each be embodied as any type of sensor or sensing device capable of generating sensor signals or other data indicative of the presence of a passenger in the autonomous vehicle 102 and/or the identification of such passengers. The particular number and type of passenger detection sensors 210 included in the in-vehicle passenger authorization system 104 may depend on the particular implementation. In the illustrative embodiment, the passenger detection sensors 210 include a camera 240, one or more seat sensors 242, and/or a microphone 244. The camera 240 may be embodied as any type of digital camera or other imaging device capable of generating images of the interior of the autonomous vehicle 102 and/or passengers located therein. In the illustrative embodiment, the camera 240 includes an electronic image sensor, such as an active-pixel sensor (APS), e.g., a complementary metal-oxide-semiconductor (CMOS) sensor, or a charge-coupled device (CCD). The seat sensors 242 may be embodied as any type of sensors capable of generating sensor signals indicative of a passenger occupying a seat of the autonomous vehicle 102. The seat sensors 242 may be embodied as simple “binary-type” sensors to detect whether or not a seat is occupied, or may be embodied as more complex sensors capable of generating sensor data indicative of the weight of the passenger occupying the corresponding seat. As such, the seat sensors 242 may be embodied as switches, strain gauges, pressure sensors, or other sensors or device capable of detecting occupancy of a seat of the autonomous vehicle 102. The microphone 244 may be embodied as any type of sensor capable of generating sensor signals indicative of audio captured form within the interior of the autonomous vehicle 102. Of course, the passenger detection sensors 210 may include additional or other sensors useful in detecting the presence of a passenger within the autonomous vehicle 102 such as motion sensors, infrared sensors, temperature sensors, and/or other sensing technology.

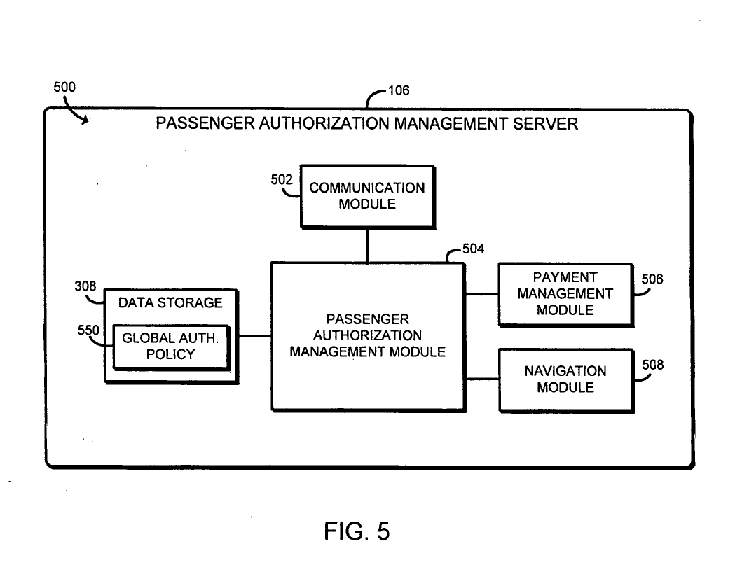

The data storage 212 may be embodied as any type of device or devices configured for short-term or long-term storage of data such as, for example, memory devices and circuits, memory cards, hard disk drives, solid-state drives, or other data storage devices. The data storage 212 may store various applications, program files, and other data used by the in-vehicle passenger authorization system 104. In the illustrative embodiment, the data storage 212 stores a passenger authorization policy 450 (see FIG. 4). As discussed in more detail below, the in-vehicle passenger authorization system 104 authorizes passengers within the autonomous vehicle 102 based on the passenger authorization policy 450. In some embodiments, the passenger authorization policy 450 may be stored in a secure portion of the data storage 212, encrypted, or otherwise protected.

The communication circuitry 214 may be embodied as any communication circuit, device, or collection thereof, capable of enabling communications between the in-vehicle passenger authorization system 104 and the passenger authorization management server 106 (and user computing device 108 in some embodiments) over the network 112. Depending on the particular type of communication modalities supported by the in-vehicle passenger authorization system 104, the communication circuitry 214 may be embodied as, or otherwise include, a cellular communication circuit, a data communication circuit, and/or other communication circuit technologies. As such, the communication circuitry 214 may be configured to use any one or more suitable communication technology (e.g., wireless or wired communications) and associated protocols (e.g., GSM, CDMA, Ethernet, Bluetooth®, Wi-Fi®, WiMAX, etc.) to effect such communication.

In some embodiments, the in-vehicle passenger authorization system 104 includes the override circuitry 216. The override circuitry 216 may be embodied as any type of circuitry capable of overriding standard functionality of the autonomous vehicle 102 to control, for example, the speed or direction of the autonomous vehicle 102. As discussed in more detail below, the in-vehicle passenger authorization system 104 may be configured to respond to instructions or requests received from an authority entity (e.g., the local police agency), which may be received by the in-vehicle passenger authorization system 104 via the communication circuitry 214. For example, in some embodiments, an authority entity may transmit an instruction via secured communication to the in-vehicle passenger authorization system 104 to cause the autonomous vehicle 102 to halt, alter the current speed, alter the current direction of travel, reroute the planned path of navigation, or perform some other request. It should be appreciated that because autonomous vehicles are generally driver-less, typical autonomous vehicles may be unable to respond to instructions or requests received from an authority entity, which can cause a security concern. However, the override circuitry 216 allows the autonomous vehicle 102 to respond to such authority instructions and, as such, may increase the safety of the autonomous vehicle 102.

The in-vehicle passenger authorization system 104 may also include one or more peripheral devices 218 in some embodiments. Such peripheral devices 218 may include any type of peripheral device commonly found in an in-vehicle computing system or other computer device, such as various input/output devices. For example, the peripheral devices 218 may include various input buttons and switches, speaker, data interface, and/or other peripheral devices.

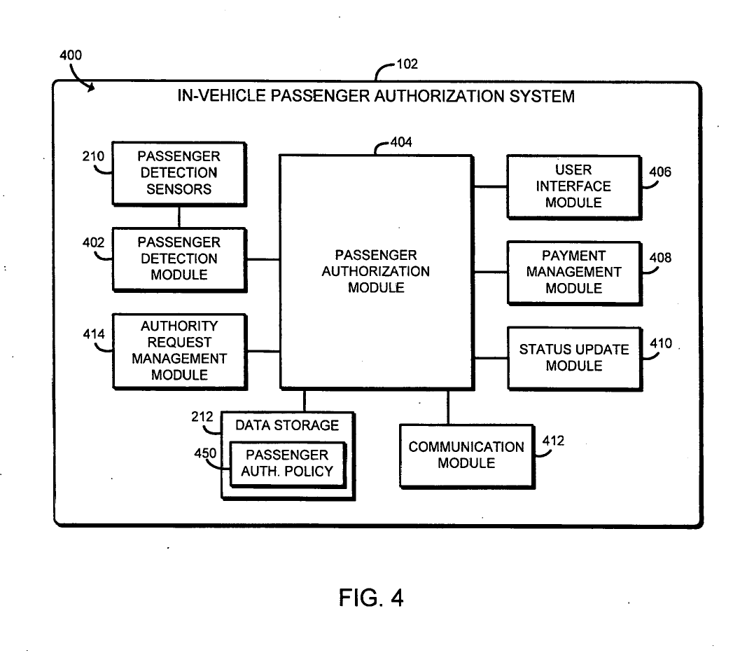

Referring back to FIG. 1, the passenger authorization management server 106 may be embodied as any type server computing device capable of receiving taxi service requests from the user computing device 108, generating the passenger authorization policy 450 based on such requests, and communicating the passenger authorization policy 450 to the autonomous vehicle 102 and/or other autonomous vehicles 110. As shown in FIG. 3, the passenger authorization management server 106 may include similar components as the in-vehicle passenger authorization system 104 such as, a processor 300, a memory 302, an I/O subsystem 304, a display 306, a data storage 308, a communication circuit 310, and/or peripheral devices 314. The individual components of the passenger authorization management server 106 may be similar to the corresponding components of the in-vehicle passenger authorization system 104, the description of which is applicable to the corresponding components of the passenger authorization management server 106 and is not repeated herein so as not to obscure the present disclosure.

Referring again back to FIG. 1, the user computing device 108 may be embodied as any type of computing device usable by the user to request taxi service from the passenger authorization management server 106 or, in some embodiments, directly from the autonomous vehicle 102 (via the in-vehicle passenger authorization system 104). For example, the user computing device 108 may be embodied as a personal computing device such as a smartphone, a cellular phone, a tablet computer, a notebook computer, a laptop computer, a desktop computer, a consumer electronic device, a smart appliance, and/or any other computing device capable of communicating with the passenger authorization management server 106 and/or the autonomous vehicle 102 over the network 112. In some embodiments, the user computing device 108 may be a public or otherwise non-private computing device. For example, in some embodiments, the user computing device 108 may be embodied as a special-purposed computing device for requesting taxi service. In one particular implementation, the user computing device 108 is embodied as a special-purposed computing device located at, for example, a kiosk of a hotel or airport for requesting taxi services. Of course, the system 100 may include additional user computing devices 108 in other embodiments.

As discussed, the in-vehicle passenger authorization system 104, the passenger authorization management server 106, and the user computing device 108 may communicate with each other over the network 112. The network 112 may be embodied as any number of various wired and/or wireless voice and/or data networks. For example, the network 112 may be embodied as, or otherwise include, a cellular network, wired or wireless local area network (LAN), a wired or wireless wide area network (WAN), and/or a publicly-accessible, global network such as the Internet. As such, the network 112 may include any number of additional devices, such as additional computers, routers, and switches to facilitate communications among the devices of the system 100.

Referring now to FIG. 4, in the illustrative embodiment, the in-vehicle passenger authorization system 104 establishes an environment 400 during operation. The illustrative environment 400 includes a passenger detection module 402, a passenger authorization module 404, a user interface module 406, a payment management module 408, a status update module 410, a communication module 412, and an authority request management module 414. Each of the various modules of the environment 400 may be embodied as hardware, firmware, software, or a combination thereof.

The passenger detection module 402 detects the presence and identity of passengers within the interior of the autonomous vehicle 102 based on sensor signals generated by the passenger detection sensors 210 as discussed above. The passenger detection module 402 may utilize any suitable methodology or sensor analysis to determine whether a passenger has entered the autonomous vehicle 102 or is otherwise presently occupying the vehicle 102. In response to detecting the presence of a passenger, the passenger detection module 402 is configured to notify the passenger authorization module 404. Additionally, the passenger detection module 402 supports the authorization of passengers by providing additional information or data to the passenger authorization module 404. Such additional information may be embodied as any type of information generated by, or generated based on, the passenger detection sensors 210 and usable by the passenger authorization module 404 to authorize the passengers. For example, in some embodiments, the passenger detection module 402 may be configured to determine the total number of passengers presently occupying the autonomous vehicle 102 based on the sensor signals of the passenger detection sensors 210 (e.g., the seat sensors 242) and provide the determined number of passengers to the passenger authorization module 404. Additionally or alternatively, the additional information may include identification information indicative of the identity of a passenger, or from which the identity can be determined or compared. For example, the passenger detection module 402 may generate images, voice recordings, or weight measurements of the passengers presently occupying the autonomous vehicle 102 and provide such identification data to the passenger authorization module 404.

The passenger authorization module 404 is configured to authorize passengers of the autonomous vehicle 102 and perform other management functions of the in-vehicle passenger authorization system 104. As discussed, the passenger authorization module 404 may authorize passengers based on the information provided by the passenger detection module 402 and the passenger authorization policy 450. The passenger authorization policy 450 may include any type of policy rule and/or other data usable by the passenger authorization module 404 to authorize the passengers of the autonomous vehicle 102. As discussed in more detail below, the passenger authorization policy 450 may be generated based on the request for taxi service and, as such, may define particular parameters of the request such as the expected number of passengers, the ages of the passengers, and/or other identification data of the passengers such as images of authorized passengers, as well as non-passenger information such as origination and destination locations. In some embodiments, the passenger authorization policy 450 may include additional “global” rules or data that is unrelated to any particular request for taxi service. Such global rules may, for example dictate the minimum age of a passenger, the maximum number of passengers (e.g., based on the type of vehicle), authorized destination locations, and/or other rules or limitations that may be applied to all taxi services.

The passenger authorization module 404 may use any suitable methodology or analysis to authorize passengers based on, for example, the information or rules contained in the passenger authorization policy 450 and/or the detection information available from the passenger detection module 402. For example, if the passenger authorization policy 450 dictates that the presently requested taxi service is for three passengers and the detection information received from the passenger detection module 402 indicates that four passengers are present, the passenger authorization module 404 may compare such information to determine that at least one passenger is not authorized (based on the requested taxi service). Alternatively, if the passenger authorization policy 450 includes an image of authorized passengers, the passenger authorization module 404 may perform an image analysis to compare images of the present passengers received from the passenger detection module 402 to the images of authorized passengers included in the passenger authorization policy 450. In some embodiments, however, an authorized passenger may be allowed to select or authorize other passengers. For example, a user requesting the taxi service may identify the authorized passenger (who may be different from the requestor) and dictate that the authorized passenger may authorize additional passengers. Such information would be included in the passenger authorization policy 450.

The user interface module 406 is configured to control the user interface device(s) 206 to provide information to passengers and receive information from passengers. For example, the user interface module 406 may present taxi service information to the user via the user interface device 206, such as the current location, expected arrival time, and/or other information. Additionally, the user interface module 406 may receive requests or query responses from the user via the user interface device 206, which is subsequently provided to the passenger authorization module 404 for processing.

Similar to the user interface module 406, the payment management module 408 manages the payment device 208. For example, the user interface module 406 may facilitate payment of a taxi service via a credit card by receiving the credit card information via the payment device 208 and communicating with payment authorization service via the communication module 412. Additionally, in embodiments in which change is provided to a paying passenger, the payment management module 408 may control the calculation and dispense of such change. In some embodiments, the payment management module 408 may be configured to communicate with the passenger authorization management server 106, via the communication module 412, to obtain billing information (e.g., the fare amount for the requested taxi service).

The status update module 410 is configured to monitor the current location of the autonomous vehicle 102 and provide taxi service updates to the passenger authorization management server 106 and/or the user computing device 108. For example, if a user requests a taxi service via the user computing device 108, the status update module 410 may periodically update the user computing device 108 with the current location of the autonomous vehicle 102, expected arrival time, unforeseen delays, and/or other information.

The communication module 412 manages and facilitates communication between the in-vehicle passenger authorization system 104 and the passenger authorization management server 106 and/or the user computing device 108. As discussed above, the communication module 412 may use any suitable communication protocol or technology to facilitate such communication.

The authority request management module 414 is configured to respond to instructions or requests received from an authority entity, such as a police agency. To do so, the authority request management module 414 may analyze any such request to determine whether the request is authentic. If so, the authority request management module 414 may control the override circuitry 216 and/or other modules or devices of the autonomous vehicle 102 (e.g., the navigation system 114) to respond to the authenticated authority request. As discussed above, such responses may include controlling the autonomous vehicle 102 to come to a stop, to change the current speed, to change direction, to switch lanes, to change its route, or perform some other function based on the received authority request. In some embodiments, the in-vehicle passenger authorization system 104 may communicate with the passenger authorization management server 106 to determine how to respond to a particular authority request.

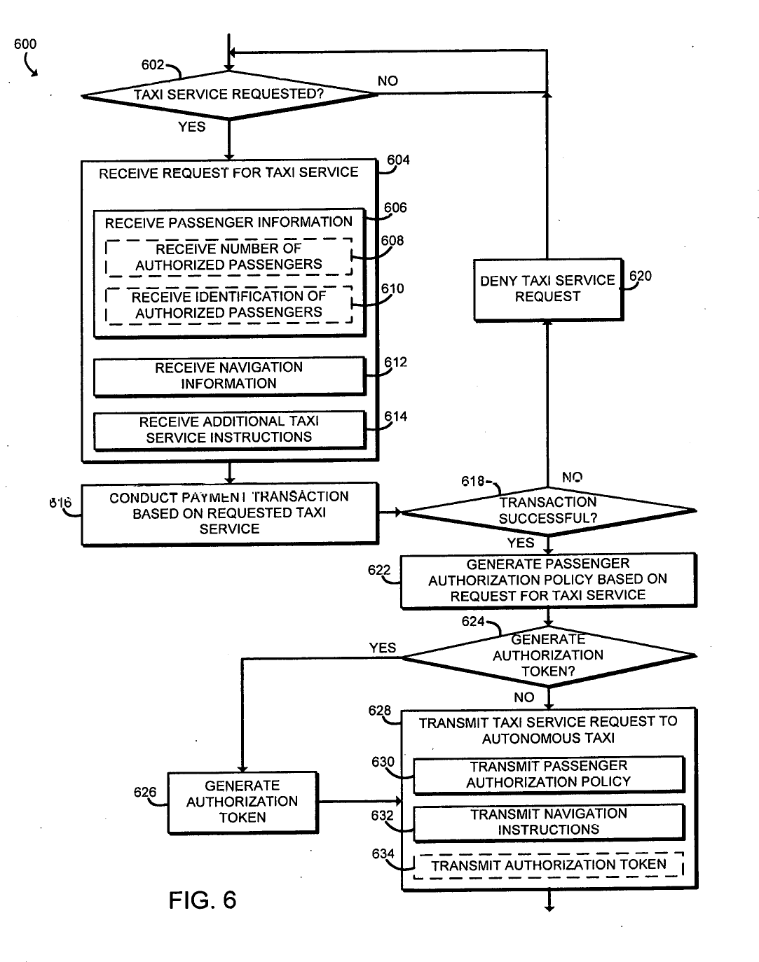

Referring now to FIG. 5, in the illustrative embodiment, the passenger authorization management server 106 establishes an environment 500 during operation. The illustrative environment 500 includes a communication module 502, a passenger authorization management module 504, a payment management module 506, and a navigation module 508. Each of the various modules of the environment 500 may be embodied as hardware, firmware, software, or a combination thereof.

The communication module 502 manages and facilitates communication between the passenger authorization management server 106 and the in-vehicle passenger authorization system 104 and/or the user computing device 108. For example, the communication module 502 may receive the request for taxi service from the user computing device 108, provide the request for taxi service to the passenger authorization management module 504 for processing, and subsequently communicate the request for taxi service and associated passenger authorization policy 450 to the selected autonomous vehicle 102. Of course, the communication module 502 may support additional or other communications during the operation of the system 100.

The passenger authorization management module 504 is configured to receive requests for taxi services and generate passenger authorization policies 450 for the implementation by the autonomous vehicles based on the received request and, in some embodiments, a global authorization policy 550. As discussed above, the passenger authorization policy 450 includes a set of rules and/or data (e.g., total number of passengers, age of passengers, images of passengers, etc.) based usable by the in-vehicle passenger authorization system 104 to authorize or verify passengers based on the particular request. To generate a rule or other data for a passenger authorization policy 450, the passenger authorization management module 504 may analyze the particular request for taxi service to infer or interpret requirements therefrom (e.g., the total number of authorized passengers). Additionally or alternatively, the passenger authorization management module 504 may extract information from the request to generate a rule or data for the passenger authorization policy (e.g., an image of the authorized passenger received with the request). In some embodiments, the user may be pre-registered with the passenger authorization management server 106, which may store identification data of the user (e.g., images, driver license number, account number, personal identification number, etc.). In such embodiments, the passenger authorization management module 504 may utilize the stored identification data to generate the passenger authorization policy 450.

In some embodiments, the passenger authorization management module 504 may modify, update, or otherwise generate the passenger authorization policy 450 based on a global authorization policy 550 maintained by the passenger authorization management server 106. The global authorization policy 550 defines a set of rules and/or other data applicable to all taxi services and which may be unrelated to any particular request for a taxi service, For example, the rules or data of the global authorization policy 550 may dictate a minimum age of a passenger, the maximum number of passengers, authorized or restricted destination locations, and/or other rules or limitations that may be applied to all taxi services of all autonomous vehicle 102, 110. As such, the passenger authorization management module 504 may generate or modify the passenger authorization policy 450 to ensure the rules and/or data of the policy 450 conform with the global authorization policy 550.

The payment management module 506 manages payment of the requested taxi service by the user of the user computing device 108. For example, the payment management module 506 may determine a total fare amount for the requested taxi service, communicate with the user computing device 108 to receive payment information, and subsequently communicate with a payment authorization service to request payment authorization. Upon successful payment, the passenger authorization management module 504 may begin generation of the passenger authorization policy 450 and communicate the taxi service request (including the passenger authorization policy 450) to the autonomous vehicle 102 to initiate the taxi service.

The navigation module 508 is configured to determine navigation instructions for the autonomous vehicle 102 based on the requested taxi service and map data stored by the passenger authorization management server 106. For example, the navigation module 508 may determine an origination location (i.e., the location at which to pick up the passengers), a destination location (i.e., the location at which to drop off the passengers), and a route between the origination and destination locations. The navigation module 508 may provide such information to the passenger authorization management module 504 for calculation of the taxi service fare and for communication to the autonomous vehicle 102 to facilitate navigation by the autonomous vehicle 102. Should re-routing of the defined navigation route be desired or needed, the navigation module 508 may perform such re-routing determination.

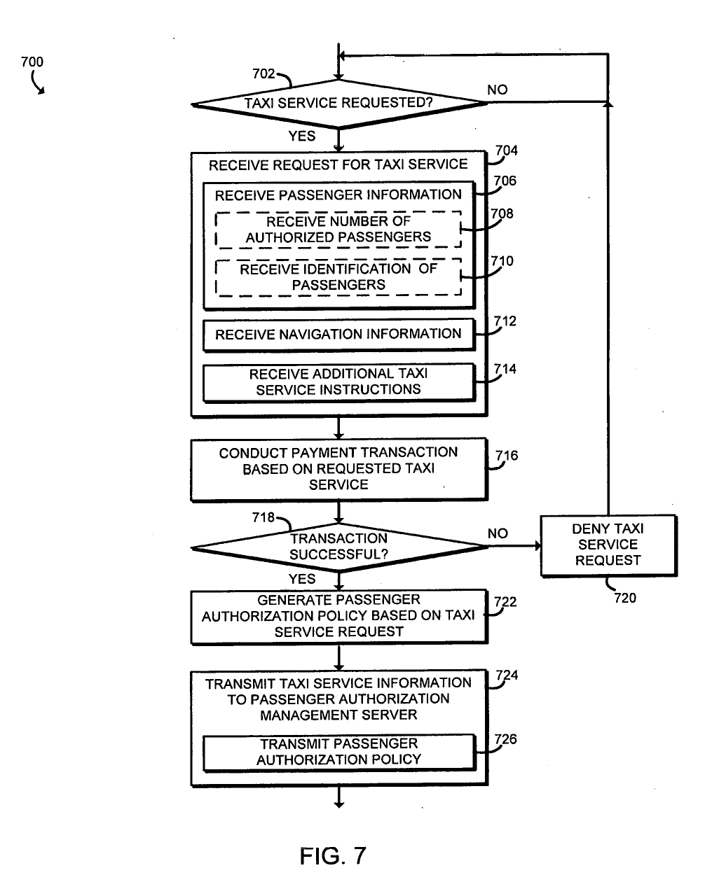

Referring now to FIG. 6, in use, the passenger authorization management server 106 may execute a method 600 for responding to a request for taxi service received from the user computing device 108. The method 600 begins with block 602 in which the passenger authorization management server 106 determines whether a taxi service request has been received. If so, the method 600 advances to block 604 in which the passenger authorization management server 106 receives the request for taxi service from the user computing device 108. As discussed above, the request for taxi service may include information defining various parameters of the request including, for example, passenger information, navigation information, and/or other information. As such, in block 606, the passenger authorization management server 106 receives or determines passenger information based on the request for taxi service. For example, in block 608, the passenger authorization management server 106 may receive or otherwise determine the number of authorized passengers identified for the requested taxi service. Additionally, in block 610, the passenger authorization management server 106 may receive or otherwise determine identification data of the authorized passengers. Such identification data may be embodied as any type of data usable to identify, or otherwise verify the identity of, an authorized passenger. For example, the identification data may include an image of the authorized passenger, a name or driver's license number of the authorized passenger, an age or weight of the authorized passenger, and/or other identification data or related information.

In block 612, the passenger authorization management server 106 may also receive or determine navigation information based on the request for taxi service. For example, the server 106 may determine an origination location, a destination location, a time for pick-up, and/or other navigation information. Additionally, in some embodiments, the passenger authorization management server 106 may receive or determine additional taxi service instructions or information in block 614. Such additional taxi service instructions may include any type of additional requests or instructions on which the passenger authorization management server 106 may generate or modify the passenger authorization policy 450. For example, the additional taxi service instructions may define whether the passenger is authorized to change the destination location or otherwise control the navigation of the autonomous vehicle 102 (e.g., a parent may be requesting the taxi service for their child and request that the child be unable to change the destination location during the taxi service ride).

After the request for taxi service has been received in block 604, the passenger authorization management server 106 determines a total fare for the requested service (e.g., based on information provided by the navigation module 508 as discussed above) and conducts a payment transaction with the user computing device 108 in block 616. The passenger authorization management server 106 may be configured to facilitate any type of long distance payment such as payment by credit card or account. If the payment transaction is determined to be unsuccessful in block 618, the method 600 advances to block 620 in which the taxi service request is denied. For example, the passenger authorization management server 106 may transmit a notification of denial to the user computing device 108 in block 620. Subsequently, the method 600 loops back to block 602 to await another taxi service request.

If, however, the payment transaction is determined to be successful in block 618, the method 600 advances to block 622 in which the passenger authorization management server 106 generates the passenger authorization policy 450. As discussed in detail above, the passenger authorization management server 106 may generate the passenger authorization policy 450 based information derived from the request for taxi service and/or the global authorization policy 550.

In block 624, the passenger authorization management server 106 determines whether to generate an authorization token. If so, the method 600 advances to block 626 in which the passenger authorization management server 106 generates the authorization token. The authorization token may be embodied as any type of data usable by a passenger to authorize the passenger to the in-vehicle passenger authorization system 104. For example, the authorization token may be embodied as a personal identification number, a passcode, a password, a quick response (QR) code, an image, or other security data. Upon arrival of the autonomous vehicle 102, the passenger may authorize himself/herself by supplying the authorization token to the in-vehicle passenger authorization system 104. For example, the passenger may enter a password or pin into the user interface device 206 via the keyboard 222. Alternatively, in embodiments in which the authorization token is a QR code, image, or other visual security data, the user may display the authorization token on the user computing device 108 (or other personal computing device of the user) to a camera or other image sensor of the in-vehicle passenger authorization system 104. The authorization token may be generated randomly or may be based on the request for taxi service, on identification data of the user requesting the taxi service, or on other data. It should be appreciated that use of an authorization token may allow a passenger to actively authorize herself/himself to the in-vehicle passenger authorization system 104 in addition to, or in place of, passive authorization by the in-vehicle passenger authorization system 104.

After an authorization token has been generated in block 626 or if no authorization token is desired, the method 600 advances to block 628 in which the passenger authorization management server 106 selects an autonomous vehicle 102 to perform the requested taxi service and transmits the request for taxi service to the selected autonomous vehicle 102. The request for taxi service transmitted by the passenger authorization management server 106 may be similar to, or otherwise include similar information as, the original request received from the user computing device 108, along with additional information to allow the autonomous vehicle 102 to provide the taxi service. For example, in block 630, the passenger authorization policy 450 generated in block 622 is transmitted to the autonomous vehicle 102 (e.g., as part of the request for taxi service) in block 630 and navigation instructions (e.g., origination location, destination location, and route information) are transmitted to the autonomous vehicle 102 in block 632. Additionally, in embodiments in which an authorization token was generated in block 626, the passenger authorization management server 106 may transmit the authorization token with the request for taxi service in block 634.

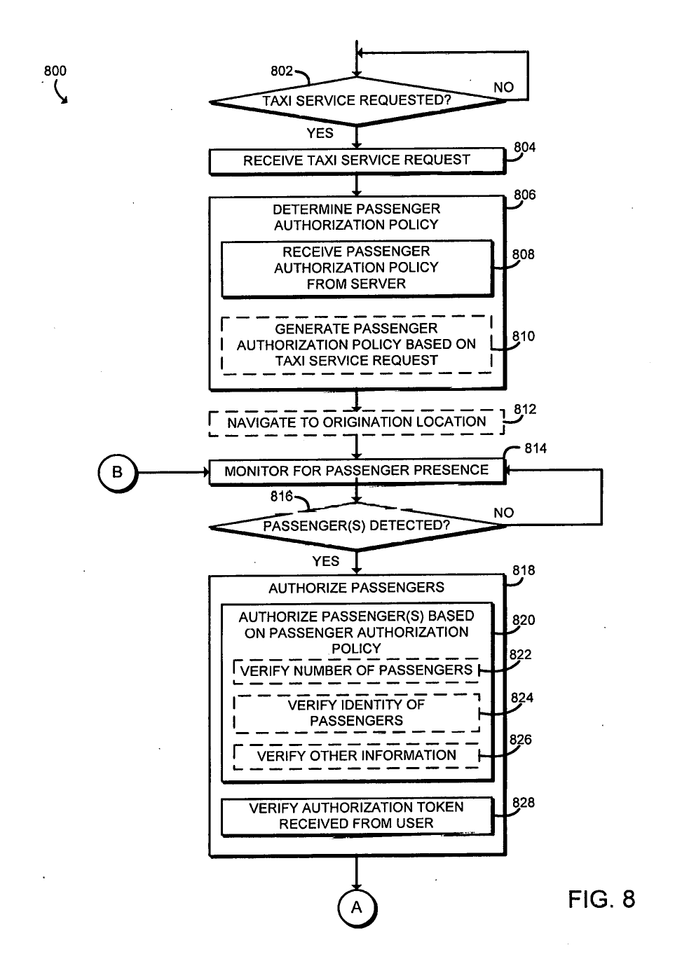

Referring now to FIG. 7, in some embodiments, a user requesting taxi service may request such service directly from the autonomous vehicle 102 either via the user computing device 108 (i.e. over the network 112) or at the autonomous vehicle 102 via the user interface device 206 of the in-vehicle passenger authorization system 104. In such embodiments, the in-vehicle passenger authorization system 104 may execute a method 700 for responding to a request for taxi service. The method 700 begins with block 702 in which the in-vehicle passenger authorization system 104 determines whether a taxi service request has been received. If so, the method 700 advances to block 704 in which the in-vehicle passenger authorization system 104 receives the request for taxi service from the user computing device 108 (or via the user interface device 206). As discussed above, the request for taxi service may include information defining various parameters of the request including, for example, passenger information, navigation information, and/or other information. As such, in block 706, the in-vehicle passenger authorization system 104 receives or determines passenger information based on the request for taxi service. For example, in block 708, the in-vehicle passenger authorization system 104 may receive or otherwise determine the authorized number of passengers. Additionally, in block 710, the in-vehicle passenger authorization system 104 may receive or otherwise determine identification data of the authorized passengers. Again, such identification data may be embodied as any type of data usable to identify, or otherwise verify the identity of, an authorized passenger including, for example, an image of the authorized passenger, a name or driver's license number of the authorized passenger, an age or weight of the authorized passenger, and/or other identification data or related information.

In block 712, the in-vehicle passenger authorization system 104 may also receive or determine navigation information based on the request for taxi service. Additionally, the in-vehicle passenger authorization system 104 may receive or determine additional taxi service instructions or information in block 714. Again, such additional taxi service instructions may include any type of additional requests or instructions on which the in-vehicle passenger authorization system 104 may generate or modify the passenger authorization policy 450 as discussed above with regard to block 614 of method 600.

After the request for taxi service has been received in block 704, the in-vehicle passenger authorization system 104 determines a total fare for the requested service and conducts a payment transaction with the user requesting taxi service in block 716. The in-vehicle passenger authorization system 104 may determine the total fare independently in some embodiments, or may communicate with the passenger authorization management server 106 to determine the total fare in other embodiments (e.g., based on information provided by the navigation module 508 as discussed above). Additionally, the payment transaction may be conducted using the payment device 208 of the in-vehicle passenger authorization system 104 in some embodiments. Alternatively, the payment transaction may be completed with the user computing device 108 (or other personal computing device of the user) as discussed above in regard to block 616 of method 600. Regardless, the in-vehicle passenger authorization system 104 determines if the payment transaction was successful in block 718. If not, the method 700 advances to block 720 in which the taxi service request is denied, and the method 700 subsequently loops back to block 702 to await a new taxi service request.

If, however, the payment transaction is determined to be successful in block 718, the method 700 advances to block 722 in which the in-vehicle passenger authorization system 104 generates the passenger authorization policy 450. To do so, the in-vehicle passenger authorization system 104 may generate the passenger authorization policy 450 independently (e.g., based solely on the request for taxi service) or in conjunction with the passenger authorization management server 106. For example, the in-vehicle passenger authorization system 104 may communicate with the passenger authorization management server 106 to obtain or access the global authorization policy 550 to facilitate generation of the passenger authorization policy 450 based thereon.

After the passenger authorization policy 450 has been generated or otherwise determined in block 722, the method 700 advances to block 724 in which the in-vehicle passenger authorization system 104 transmits taxi service information to the passenger authorization management server 106. Such taxi service information may include the request for taxi service and/or information generated therefrom, such as the origination location, destination location, payment details, and/or passenger information. Additionally, in embodiments in which the in-vehicle passenger authorization system 104 generated the passenger authorization policy 450, the in-vehicle passenger authorization system 104 may transmit the passenger authorization policy to the passenger authorization management server 106 in block 726. In such embodiments, the passenger authorization management server 106 may store and/or validate the passenger authorization policy.

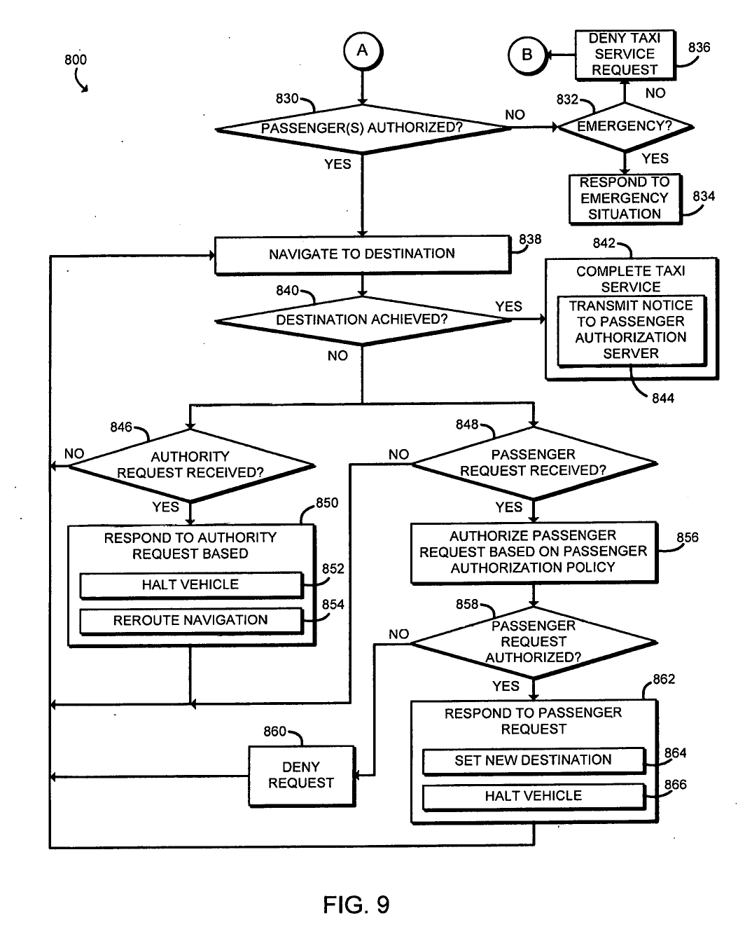

Referring now to FIGS. 8 and 9, in use, the in-vehicle passenger authorization system 104 may execute a method 800 for authorizing a passenger(s) of the autonomous vehicle 102. The method 800 begins with block 802 in which the in-vehicle passenger authorization system 104 determines whether taxi service has been requested. If so, the method 800 advances to block 804 in which the in-vehicle passenger authorization system 104 receives the taxi service request. As discussed above, the request for taxi service may be received from the passenger authorization management server 106, from the user computing device 108, or from the user interface devices 206 of the in-vehicle passenger authorization system 104 itself.

After the taxi service request has been received in block 804, the in-vehicle passenger authorization system 104 determines the passenger authorization policy 450 for the requested taxi service in block 806. To do so, in some embodiments, the in-vehicle passenger authorization system 104 may receive the passenger authorization policy 450 directly from the passenger authorization management server 106 in block 808 (e.g., as part of the taxi service request received from the server 106 in block 804). Alternatively, in other embodiments, the in-vehicle passenger authorization system 104 may generate the passenger authorization policy 450 itself based on the request for taxi service as discussed in detail above in regard to method 700 of FIG. 7.

In block 812, if required, the autonomous vehicle 102 navigates to the origination location as defined in the request for taxi service. Upon arrival at the origination location (or if the autonomous vehicle 102 is already at the origination location), the in-vehicle passenger authorization system 104 begins monitoring for the presence of a passenger. To do so, the in-vehicle passenger authorization system 104 may monitor the sensor signals generated by the passenger detection sensors 210 to determine whether a passenger is present within the interior of the autonomous vehicle 102 (e.g., based on sensor data generated by the camera 240, a seat sensor 242, the microphone 244, a motion sensor, or other passenger detection sensor 210).

If the in-vehicle passenger authorization system 104 determines that a passenger is present, the method 800 advances to block 818 in which the in-vehicle passenger authorization system 104 attempts to authorize the detected passengers. For example, the in-vehicle passenger authorization system 104 may authorize the detected passengers based on the passenger authorization policy 450 in block 820. To do so, the in-vehicle passenger authorization system 104 may compare the rules or data of the passenger authorization policy 450 to the data or other information provided by the passenger detection module 402 (via the passenger detection sensors 210). For example, if the passenger authorization policy 450 dictates the authorized number of passengers, the in-vehicle passenger authorization system 104 may compare the authorized number of passengers to the number of detected passengers to determine whether the passengers are authorized (e.g., are there too many passengers based on the passenger authorization policy 450).

Additionally or alternatively, if the passenger authorization policy 450 provides identification data for the authorized passengers, the in-vehicle passenger authorization system 104 may compare data indicative of the identification of present passengers, which may be received from the passenger detection module 402, to the identification data included in the passenger authorization policy 450. For example, in some embodiments, the in-vehicle passenger authorization system 104 may compare a captured image or voice audio of a present passenger to an image or recording of an authorized passenger included in the passenger authorization policy 450. Additionally or alternatively, the in-vehicle passenger authorization system 104 may analyze the captured image of the present passenger to determine or estimate an age of the present passenger and compare the estimated age to an age of the authorized passenger identified in the passenger authorization policy 450. Further, the in-vehicle passenger authorization system 104 may determine an estimated weight of the passenger based on the sensor signals generated by the seat sensors 242 and compare the estimated weight to a weight or age identified in the passenger authorization policy 450. Of course, it should be appreciated that the in-vehicle passenger authorization system 104 may use additional or other sensed, captured, inferred, or otherwise determined data or information about the present passenger to compare to the passenger authorization policy 450 to thereby determine whether the present passenger is authorized.

As discussed above, in some embodiments, an authorization token may be generated and provided to the user requesting taxi service to allow the user to actively authenticate to the in-vehicle passenger authorization system 104. As such, if the user has provided an authorization token, the in-vehicle passenger authorization system 104 validates the authorization token in block 828. To do so, in some embodiments, the in-vehicle passenger authorization system 104 may communicate with the passenger management authorization server 106 to determine the validity of the authorization token. In some embodiments, the use of an authorization token may override other passenger authorization procedures. For example, an authorization token may be used by a user requesting taxi service for a third party (e.g., a parent requesting taxi service for a child).

In block 830 (see FIG. 9), the in-vehicle passenger authorization system 104 determines whether the present passenger(s) is authorized. If not, the method 800 advances to block 832 in which the in-vehicle passenger authorization system 104 determines whether an emergency situation is occurring. To do so, the in-vehicle passenger authorization system 104 may utilize any suitable methodology or technology to determine the occurrence of an emergency situation. For example, in some embodiments, the in-vehicle passenger authorization system 104 may determine an emergency situation is occurring based on the destination of the taxi service (e.g., a hospital) or based on information provided by the passenger via the user interface device 206 (e.g., in response to the passenger selecting a “emergency” button or option). If the in-vehicle passenger authorization system 104 determines that an emergency situation is occurring, the method 800 advances to block 834 in which the in-vehicle passenger authorization system 104 responds to the emergency situation. Such response may be based on the particular type of emergency, information supplied by the passenger (e.g., via the user interface device 206), policy rules of the passenger authorization policy 450, and/or other criteria. For example, the in-vehicle passenger authorization system 104 may immediately authorize the passenger and transfer the passenger to the desired destination (e.g., a hospital), contact emergency responders, or perform some other action based on the emergency situation, the passenger authorization policy 450, or other information.

If, however, the in-vehicle passenger authorization system 104 determines that no emergency situation is occurring in block 832, the method 800 advances to block 836 in which the taxi service request is denied. Additionally, the in-vehicle passenger authorization system 104 may transmit a notification of the denial to the passenger authorization management server 106 in some embodiments. Regardless, the method 800 loops back to block 814 to continue monitoring for authorized passengers.

If, however, the present passenger(s) have been authorized in block 830, the method 800 advances to block 838 in which the autonomous vehicle 102 navigates to the desired destination location. As discussed above, the autonomous vehicle 102 may use any autonomous navigation technology or mechanisms to successfully navigate to the destination location. If the destination location has been reached in block 840, the method 800 advances to block 842 wherein the requested taxi service is completed. For example, in some embodiments, the payment transaction may be fully completed in block 842. Additionally, the in-vehicle passenger authorization system 104 may transmit a notice that the taxi service has been successfully completed to the passenger authorization management server 106 in block 844.

If, however, the destination location has not been reached, the method 800 advances to blocks 846 and 848. In block 846, the in-vehicle passenger authorization system 104 determines whether a request from an authority entity (e.g., a police agency) has been received while navigating to the destination location. As discussed above, the authority request may be embodied as a secure communication from an emergency vehicle or other authority device or entity. If not, the method 800 loops back to block 838 wherein the autonomous vehicle 102 continues navigating to the destination location. However, if an authority request has been received in block 846, the method 800 advances to block 850 in which the in-vehicle passenger authorization system 104 responds to the authority request. For example, in some embodiments, the in-vehicle passenger authorization system 104 may cause the autonomous vehicle to stop or come to a halt in block 852 or reroute the planned navigation route in block 854 in response to the authority request. Once the authority request has been responded to and the in-vehicle passenger authorization system 104 determines that continued navigation is safe, the method 800 loops back to block 838 wherein the autonomous vehicle 102 continues navigation to the destination location.

Referring back to block 848, the in-vehicle passenger authorization system 104 determines whether a passenger request has been received while navigation to the destination location in block 848. As discussed above, the passenger may interact with the in-vehicle passenger authorization system 104 via the user interface device 206 or the user computing device 108 to submit, for example, requests to the autonomous vehicle 102. If no passenger request is received in block 848, the method 800 loops back to block 838 wherein the autonomous vehicle 102 continues navigating to the destination location. However, if a passenger request is received, the in-vehicle passenger authorization system 104 determines whether the passenger request is authorized based on the passenger authorization policy 450 in block 858. For example, as discussed above, the request for taxi service may include additional instructions or information usable to generate or modify the passenger authorization policy 450. Such additional instructions may place restrictions on the activities of passengers. For example, a parent may request taxi service for a child and request that the child be unable to change the destination location of the taxi service request. In such embodiments, the passenger authorization policy 450 would include a rule or other data identifying that such a request is unauthorized. Additionally, in some embodiments, the global authorization policy 550 may include global rules restricting requests during navigation of the autonomous vehicle 102, which may be incorporated in the passenger authorization policy 450.

In block 858, the in-vehicle passenger authorization system 104 determines whether the passenger request is authorized. If not, the request is denied in block 860, and the method 800 loops back to block 838 wherein the autonomous vehicle 102 continues navigation to the destination location. However, if the passenger request is authorized, the method 800 advances to block 862 in which the in-vehicle passenger authorization system 104 responds to or otherwise performs the passenger request. For example, in block 864, the in-vehicle passenger authorization system 104 may set a new destination location or halt the autonomous vehicle 102 in block 866. Regardless, after the in-vehicle passenger authorization system 104 has responded to the passenger request, the method 800 loops back to block 838 wherein the autonomous vehicle 102 continues navigation to the destination location.

### EXAMPLES

Illustrative examples of the devices, systems, and methods disclosed herein are provided below. An embodiment of the devices, systems, and methods may include any one or more, and any combination of, the examples described below.

Example 1 includes an in-vehicle passenger authorization system of an autonomous vehicle, the in-vehicle passenger authorization system comprising a passenger authorization module to determine a passenger authorization policy based on a request for a taxi service; and a passenger detection module to detect the presence of a passenger in the autonomous vehicle based on an output of at least one passenger detection sensor of the autonomous vehicle; wherein the passenger authorization module is to determine, in response to detection of the presence of the passenger, whether the passenger is authorized for the taxi service based on the passenger authorization policy.

Example 2 includes the subject matter of Example 1, and further comprising a user interface module to receive the request for the taxi service from a user.

Example 3 includes the subject matter of any of Examples 1 and 2, and further including a communication module to receive the request for the taxi service from a passenger authorization management server.

Example 4 includes the subject matter of any of Examples 1-3, and wherein the communication module is to receive the passenger authorization policy with the request for the taxi service from the passenger authorization management server.

Example 5 includes the subject matter of any of Examples 1-4, and wherein the passenger authorization policy defines an authorized number of passengers, and wherein the passenger detection module is to determine a present number of passengers in the autonomous vehicle; and the passenger authorization module is to determine whether the passenger is authorized based on a comparison of the present number of passengers to the authorized number of passengers.

Example 6 includes the subject matter of any of Examples 1-5, and wherein the passenger authorization policy defines identification data of an authorized passenger, and wherein the passenger detection module is to obtain identification data of the passenger of the autonomous vehicle; and the passenger authorization module is to determine whether the passenger is authorized based on a comparison of the identification data of the passenger to the identification data of the authorized passenger.

Example 7 includes the subject matter of any of Examples 1-6, and wherein the passenger authorization policy includes an image of the authorized passenger, and wherein the passenger detection module is to capture an image of the passenger while the passenger is in the autonomous vehicle; and the passenger authorization module is to determine whether the passenger is authorized based on a comparison of the captured image of the passenger to the image of the authorized passenger.

Example 8 includes the subject matter of any of Examples 1-7, and wherein the passenger authorization policy identifies an age of the authorized passenger, and wherein the passenger detection module is to determine identification data of the passenger; the passenger authorization module is to estimate an age of the passenger based on the identification data and determine whether the passenger is authorized based on a comparison of the estimated age of the passenger to the age of the authorized passenger.

Example 9 includes the subject matter of any of Examples 1-8, and further including a camera, and wherein the passenger detection module is to operate the camera to generate an image of the passenger; and the passenger authorization module is to estimate the age of the passenger based on the image of the passenger.

Example 10 includes the subject matter of any of Examples 1-9, and further including a microphone, and wherein the passenger detection module is to capture audio of the passenger's voice; and the passenger authorization module is to estimate the age of the passenger based on the captured audio of the passenger's voice.

Example 11 includes the subject matter of any of Examples 1-10, and further including a seat sensor to generate a sensor signal indicative of a weight of a seated passenger, wherein the passenger detection module is to determine a weight of the passenger based on the sensor signal; and the passenger authorization module is to estimate the age of the passenger based on the determined weight of the passenger.

Example 12 includes the subject matter of any of Examples 1-11, and further including a user interface module to receive an authorization token from the user, wherein the passenger authorization module is to determine whether the passenger is authorized based on a verification of the authorization token based on the passenger authorization policy.

Example 13 includes the subject matter of any of Examples 1-12, and wherein the authorization token comprises a personal identification number or a password.

Example 14 includes the subject matter of any of Examples 1-13, and wherein the passenger authorization module is to receive the request for the taxi service from a passenger authorization management server or from a user computing device.

Example 15 includes the subject matter of any of Examples 1-14, and wherein the passenger authorization module is to determine the passenger authorization policy based on a global authorization policy that defines a set of rules for all taxi services performed by the autonomous vehicle.

Example 16 includes the subject matter of any of Examples 1-15, and wherein the request for taxi service includes an identification of the number of authorized passengers; and wherein the passenger authorization module is to generate a policy rule of the passenger authorization policy that restricts the number of passengers of the autonomous vehicle to the number of authorized passengers.

Example 17 includes the subject matter of any of Examples 1-16, and wherein the request for taxi service comprises identification data of an authorized passenger; and wherein the passenger authorization module is to generate the passenger authorization policy based on the identification data of the authorized passenger.

Example 18 includes the subject matter of any of Examples 1-17, and wherein the identification data comprises an image of the authorized passenger, and wherein the passenger authorization module is to incorporate the image of the authorized passenger into the passenger authorization policy.

Example 19 includes the subject matter of any of Examples 1-18, and wherein the identification data comprises an age of the authorized passenger, and wherein the passenger authorization module is to generate a policy rule of the passenger authorization policy restricting the age of a passenger of the autonomous vehicle to the age of the authorized passenger.

Example 20 includes the subject matter of any of Examples 1-19, and wherein the request for taxi service comprises a restriction on the ability of an authorized passenger to modify a destination of requested taxi service; and wherein the passenger authorization module is to generate a policy rule of the passenger authorization policy restricting the ability of a passenger of the autonomous vehicle to modify the destination.

Example 21 includes the subject matter of any of Examples 1-20, and further including a seat sensor to generate a sensor signal indicative of a presence of a passenger occupying a seat of the autonomous vehicle, and wherein the passenger detection module is to detect the presence of the passenger based on the sensor signal.

Example 22 includes the subject matter of any of Examples 1-21, and further including a camera to generate an image of an interior of the autonomous vehicle, and wherein the passenger detection module is to detect the presence of a passenger of autonomous vehicle based on the captured image.

Example 23 includes the subject matter of any of Examples 1-22, and further including a microphone to capture audio within the interior of the autonomous vehicle, and wherein the passenger detection module is to detect the presence of the passenger of the autonomous vehicle based on the captured audio.

Example 24 includes the subject matter of any of Examples 1-23, and further wherein the passenger authorization module is to deny the request for the taxi service in response to a determination that the passenger is not authorized.

Example 25 includes the subject matter of any of Examples 1-24, and further including a navigation system to navigate the autonomous vehicle to a destination defined in the request for taxi service in response to a determination that the passenger is authorized; a user interface module to receive a request from the passenger while the autonomous vehicle is navigating to the destination, and wherein the passenger authorization module is to cause performance of the request received from the passenger based on the passenger authorization policy.

Example 26 includes the subject matter of any of Examples 1-25, and wherein the request from the passenger comprises a request to change the destination defined in the request for taxi service or to stop the autonomous vehicle.

Example 27 includes the subject matter of any of Examples 1-26, and further including a communication module to receive a request from an authority entity; and an authority request management module to validate the request from the authority entity and cause the autonomous vehicle to respond to the request from the authority entity in response to the validation of the request.

Example 28 includes the subject matter of any of Examples 1-27, and wherein the request from the authority entity comprises a secured wireless communication.

Example 29 includes the subject matter of any of Examples 1-28, and wherein the request form the authority entity comprises a request to stop the autonomous vehicle or reroute the autonomous vehicle.

Example 30 includes a passenger authorization management server to respond to a request for taxi service, the passenger authorization management server comprising a communication module to receive a request for taxi service from a computing device of a user; and a passenger authorization management module to generate a passenger authorization policy based on the request for the taxi service, the passenger authorization policy comprising a set of policy rules usable by an autonomous vehicle to authorize a passenger, wherein the communication module is to transmit the request for taxi service and the passenger authorization policy to the autonomous vehicle.

Example 31 includes the subject matter of Example 30, and wherein the request for taxi service comprises an identification of the number of authorized passengers, and wherein the passenger authorization management module is to generate a policy rule of the passenger authorization policy restricting the number of passengers of the autonomous vehicle to the number of authorized passengers.

Example 32 includes the subject matter of any of Examples 30 and 31, and wherein the request for taxi service comprises identification data of an authorized passenger, and wherein the passenger authorization management module is to generate the passenger authorization policy based on the identification data of the authorized passenger.

Example 33 includes the subject matter of any of Examples 30-32, and wherein the identification data comprises an image of the authorized passenger, and wherein the passenger authorization management module is to incorporate the image of the authorized passenger into the passenger authorization policy.

Example 34 includes the subject matter of any of Examples 30-33, and wherein the identification data comprises an age of the authorized passenger, and wherein the passenger authorization management module is to generate a policy rule of the passenger authorization policy restricting the age of a passenger of the autonomous vehicle to the age of the authorized passenger.

Example 35 includes the subject matter of any of Examples 30-34, and wherein the request for taxi service comprises a restriction on the ability of an authorized passenger to modify a destination of requested taxi service, and wherein the passenger authorization management module is to generate a policy rule of the passenger authorization policy restricting the ability of a passenger of the autonomous vehicle to modify the destination.

Example 36 includes the subject matter of any of Examples 30-35, and wherein the passenger authorization management module is to generate an authorization token based on the request for taxi service, the authorization token usable by the user to authorize a passenger, and the communication module is to transmit the authorization token to the computing device of the user.

Example 37 includes the subject matter of any of Examples 30-36, and wherein the authorization token comprises a personal identification number or a password.

Example 38 includes the subject matter of any of Examples 30-37, and further including a data storage having stored therein a global authorization policy that defines a set of rules for all taxi services performed by the autonomous vehicle, and wherein the passenger authorization module is to generate the passenger authorization policy based on the global authorization policy.

Example 39 includes a method for authorizing a passenger of an autonomous vehicle, the method comprising receiving, by an in-vehicle passenger authorization system of the autonomous vehicle, a request for a taxi service; determining, by the in-vehicle passenger authorization system, a passenger authorization policy based on the request; detecting, by the in-vehicle passenger authorization system, the presence of a passenger in the autonomous vehicle; and determining, by the in-vehicle passenger authorization system, whether the passenger is authorized for the taxi service based on the passenger authorization policy and in response to detecting the presence of the passenger.

Example 40 includes the subject matter of Example 39, and wherein determining a passenger authorization policy comprises receiving the passenger authorization policy from a passenger authorization management server.

Example 41 includes the subject matter of any of Examples 39 and 40, and wherein the passenger authorization policy defines an authorized number of passengers, and wherein determining whether the passenger is authorized comprises determining a present number of passengers in the autonomous vehicle; and determining whether the passenger is authorized by comparing the current number of passengers to the authorized number of passengers.

Example 42 includes the subject matter of any of Examples 39-41, and wherein the passenger authorization policy defines identification data of an authorized passenger, and wherein determining whether the passenger is authorized comprises obtaining identification data of the passenger of the autonomous vehicle; and determining whether the passenger is authorized by comparing the identification data of the passenger to the identification data of the authorized passenger.

Example 43 includes the subject matter of any of Examples 39-42, and wherein the passenger authorization policy includes an image of the authorized passenger, and wherein determining whether the passenger is authorized comprises capturing an image of the passenger while the passenger is in the autonomous vehicle; and determining whether the passenger is authorized by comparing the captured image of the passenger to the image of the authorized passenger.

Example 44 includes the subject matter of any of Examples 39-43, and wherein the passenger authorization policy identifies an age of the authorized passenger, and wherein determining whether the passenger is authorized comprises determining identification data of the passenger; estimating an age of the passenger based on the identification data; and determining whether the passenger is authorized by comparing the estimated age of the passenger to the age of the authorized passenger.

Example 45 includes the subject matter of any of Examples 39-44, and wherein determining identification data of the passenger comprises generating an image of the passenger; and estimating the age of the passenger comprises estimating the age of the passenger based on the image of the passenger.

Example 46 includes the subject matter of any of Examples 39-45, and wherein determining identification data of the passenger comprises capturing audio of the passenger's voice; and estimating the age of the passenger comprises estimating the age of the passenger based on the captured audio of the passenger's voice.

Example 47 includes the subject matter of any of Examples 39-46, and wherein determining identification data of the passenger comprises determining a weight of the passenger based on a sensor signal generated by a seat sensor of the autonomous vehicle; and estimating the age of the passenger comprises estimating the age of the passenger based on the determined weight of the passenger.

Example 48 includes the subject matter of any of Examples 39-47, and wherein determining whether the passenger is authorized comprises receiving an authorization token from the user; and verifying the authorization token based on the passenger authorization policy.

Example 49 Includes the subject matter of any of Examples 39-48, and wherein the authorization token comprises a personal identification number or a password.

Example 50 includes the subject matter of any of Examples 39-49, and wherein receiving the request for the taxi service comprises receiving the request from a passenger authorization management server or from a user computing device.

Example 51 includes the subject matter of any of Examples 39-50, and wherein determining a passenger authorization policy comprises determining a passenger authorization policy based on a global authorization policy that defines a set of rules for all taxi services performed by the autonomous vehicle.

Example 52 includes the subject matter of any of Examples 39-51, and wherein receiving the request for taxi service comprises receiving an identification of the number of authorized passengers; and determining the passenger authorization policy comprises generating, by the in-vehicle passenger authorization system, a policy rule restricting the number of passengers of the autonomous vehicle to the number of authorized passengers.

Example 53 includes the subject matter of any of Examples 39-52, and wherein receiving the request for taxi service comprises receiving identification data of an authorized passenger; and determining the passenger authorization policy comprises generating, by the in-vehicle passenger authorization system, the passenger authorization policy based on the identification data of the authorized passenger.

Example 54 includes the subject matter of any of Examples 39-53, and wherein receiving identification data comprises receiving an image of the authorized passenger; and determining the passenger authorization policy comprises incorporating, by the in-vehicle passenger authorization system, the image of the authorized passenger into the passenger authorization policy.

Example 55 includes the subject matter of any of Examples 39-54, and wherein receiving identification data comprises receiving an age of the authorized passenger; and generating the passenger authorization policy comprises generating a policy rule restricting the age of a passenger of the autonomous vehicle to the age of the authorized passenger.

Example 56 includes the subject matter of any of Examples 39-55, and wherein receiving the request for taxi service comprises receiving a restriction on the ability of an authorized passenger to modify a destination of requested taxi service; and determining the passenger authorization policy comprises generating, by the in-vehicle passenger authorization system, a policy rule restricting the ability of a passenger of the autonomous vehicle to modify the destination.

Example 57 includes the subject matter of any of Examples 39-56, and wherein detecting the presence of the passenger comprises detecting the presence of the passenger based on a sensor signal generated by a seat sensor of the autonomous vehicle.

Example 58 includes the subject matter of any of Examples 39-57, and wherein detecting the presence of the passenger comprises detecting the presence of the passenger based on a captured image of an interior of the autonomous vehicle.

Example 59 includes the subject matter of any of Examples 39-58, and wherein detecting the presence of the passenger comprises detecting the presence of the passenger based on captured audio within the interior of the autonomous vehicle.

Example 60 includes the subject matter of any of Examples 39-59, and further including denying, by the in-vehicle passenger authorization system, the request for the taxi service in response to determining that the passenger is not authorized.

Example 61 includes the subject matter of any of Examples 39-60, and further including navigating, by the autonomous vehicle, to a destination defined in the request for taxi service in response to determining that the passenger is authorized; receiving, via a user interface of the in-vehicle passenger authorization system, a request from the passenger while navigating to the destination; and determining, by the in-vehicle passenger authorization system, whether to perform the request received from the passenger based on the passenger authorization policy.

Example 62 includes the subject matter of any of Examples 39-61, and wherein receiving a request from the passenger comprises receiving a request to change the destination defined in the request for taxi service or stop the autonomous vehicle.

Example 63 includes the subject matter of any of Examples 39-62, and further including receiving, by the in-vehicle passenger authorization system, a request from an authority entity; and responding, by the in-vehicle passenger authorization system, to the request.

Example 64 includes the subject matter of any of Examples 39-63, and wherein responding to the request comprises stopping the autonomous vehicle or rerouting the autonomous vehicle.

Example 65 an in-vehicle passenger authorization system comprising a processor; and a memory having stored therein a plurality of instructions that when executed by the processor cause the computing device to perform the method of any of Examples 39-64.

Example 66 includes one or more machine-readable storage media comprising a plurality of instructions stored thereon that in response to being executed result in an in-vehicle passenger authorization system performing the method of any of Examples 39-64.

Example 67 includes an in-vehicle passenger authorization system comprising means for performing the method of any of Examples 39-64.

Example 68 includes a method for responding to a request for taxi service, the method comprising receiving, by a passenger authorization management server, a request for taxi service from a computing device of a user; generating, by the passenger authorization management server, a passenger authorization policy based on the request for the taxi service, the passenger authorization policy comprising a set of policy rules usable by an autonomous vehicle to authorize a passenger; and transmitting, by the passenger authorization management server, the request for taxi service and the passenger authorization policy to the autonomous vehicle.

Example 69 includes the subject matter of Example 68, and wherein receiving the request for taxi service comprises receiving an identification of the number of authorized passengers; and generating the passenger authorization policy comprises generating a policy rule restricting the number of passengers of the autonomous vehicle to the number of authorized passengers.

Example 70 includes the subject matter of any of Examples 68 and 69, and wherein receiving the request for taxi service comprises receiving identification data of an authorized passenger; and generating the passenger authorization policy comprises generating the passenger authorization policy based on the identification data of the authorized passenger.

Example 71 includes the subject matter of any of Examples 68-70, and wherein receiving identification data comprises receiving an image of the authorized passenger; and generating the passenger authorization policy comprises incorporating the image of the authorized passenger into the passenger authorization policy.

Example 72 includes the subject matter of any of Examples 68-71, and wherein receiving identification data comprises receiving an age of the authorized passenger; and generating the passenger authorization policy comprises generating a policy rule restricting the age of a passenger of the autonomous vehicle to the age of the authorized passenger.

Example 73 includes the subject matter of any of Examples 68-72, and wherein receiving the request for taxi service comprises receiving a restriction on the ability of an authorized passenger to modify a destination of requested taxi service; and generating the passenger authorization policy comprises generating a policy rule restricting the ability of a passenger of the autonomous vehicle to modify the destination .

Example 74 includes the subject matter of any of Examples 68-73, and further including generating, by the passenger authorization management server, an authorization token based on the request for taxi service, the authorization token usable by the user to authorize a passenger; and transmitting, by the passenger authorization management server, the authorization token to the computing device of the user.

Example 75 includes the subject matter of any of Examples 68-74, and wherein the authorization token comprises a personal identification number or a password.

Example 76 includes the subject matter of any of Examples 68-75, and wherein generating the passenger authorization policy comprises generating the passenger authorization policy based on a global authorization policy that defines a set of rules for all taxi services performed by the autonomous vehicle.

Example 77 includes a passenger authorization management server comprising a processor; and a memory having stored therein a plurality of instructions that when executed by the processor cause the computing device to perform the method of any of Examples 68-76.

Example 78 includes one or more machine-readable storage media comprising a plurality of instructions stored thereon that in response to being executed result in a passenger authorization management server performing the method of any of Examples 68-76.

Example 79 includes a passenger authorization management server comprising means for performing the method of any of Examples 68-76.

1-25. (canceled)

26. An in-vehicle passenger authorization system of an autonomous vehicle, the in-vehicle passenger authorization system comprising:
a passenger authorization module to determine a passenger authorization policy based on a request for a taxi service; and
a passenger detection module to detect the presence of a passenger in the autonomous vehicle based on an output of at least one passenger detection sensor of the autonomous vehicle;
wherein the passenger authorization module is to determine, in response to detection of the presence of the passenger, whether the passenger is authorized for the taxi service based on the passenger authorization policy.

27. The in-vehicle passenger authorization system of claim 26, wherein the passenger authorization policy defines an authorized number of passengers, and wherein:
the passenger detection module is to determine a present number of passengers in the autonomous vehicle; and
the passenger authorization module is to determine whether the passenger is authorized based on a comparison of the present number of passengers to the authorized number of passengers.

28. The in-vehicle passenger authorization system of claim 26, wherein the passenger authorization policy defines identification data of an authorized passenger, and wherein:
the passenger detection module is to obtain identification data of the passenger of the autonomous vehicle; and
the passenger authorization module is to determine whether the passenger is authorized based on a comparison of the identification data of the passenger to the identification data of the authorized passenger.

29. The in-vehicle passenger authorization system of claim 28, wherein the passenger authorization policy includes an image of the authorized passenger, and wherein:
the passenger detection module is to capture an image of the passenger while the passenger is in the autonomous vehicle; and
the passenger authorization module is to determine whether the passenger is authorized based on a comparison of the captured image of the passenger to the image of the authorized passenger.

30. The in-vehicle passenger authorization system of claim 28, wherein the passenger authorization policy identifies an age of the authorized passenger, and wherein:
the passenger detection module is to determine identification data of the passenger;
the passenger authorization module is to estimate an age of the passenger based on the identification data and determine whether the passenger is authorized based on a comparison of the estimated age of the passenger to the age of the authorized passenger.

31. The in-vehicle passenger authorization system of claim 30, further comprising a camera, and wherein:
the passenger detection module is to operate the camera to generate an image of the passenger; and
the passenger authorization module is to estimate the age of the passenger based on the image of the passenger.

32. The in-vehicle passenger authorization system of claim 30, further comprising a microphone, and wherein:
the passenger detection module is to capture audio of the passenger's voice; and
the passenger authorization module is to estimate the age of the passenger based on the captured audio of the passenger's voice.

33. The in-vehicle passenger authorization system of claim 30, further comprising a seat sensor to generate a sensor signal indicative of a weight of a seated passenger, wherein:
the passenger detection module is to determine a weight of the passenger based on the sensor signal; and
the passenger authorization module is to estimate the age of the passenger based on the determined weight of the passenger.

34. The in-vehicle passenger authorization system of claim 26, further comprising a user interface module to receive an authorization token from the user,
wherein the passenger authorization module is to determine whether the passenger is authorized based on a verification of the authorization token based on the passenger authorization policy.

35. One or more machine-readable storage media comprising a plurality of instructions stored thereon that, in response to execution, cause an in-vehicle passenger authorization system of an autonomous vehicle to:
receive a request for a taxi service;
determine a passenger authorization policy based on the request;
detect the presence of a passenger in the autonomous vehicle; and
determine whether the passenger is authorized for the taxi service based on the passenger authorization policy and in response to detecting the presence of the passenger.

36. The one or more machine-readable storage media of claim 35, wherein the passenger authorization policy defines an authorized number of passengers, and wherein to determine whether the passenger is authorized comprises to:
determine a present number of passengers in the autonomous vehicle; and
determine whether the passenger is authorized by comparing the current number of passengers to the authorized number of passengers.

37. The one or more machine-readable storage media of claim 35, wherein the passenger authorization policy defines identification data of an authorized passenger, and wherein to determine whether the passenger is authorized comprises to:
obtain identification data of the passenger of the autonomous vehicle; and
determine whether the passenger is authorized by comparing the identification data of the passenger to the identification data of the authorized passenger.

38. The one or more machine-readable storage media of claim 37, wherein the passenger authorization policy includes an image of the authorized passenger, and wherein to determine whether the passenger is authorized comprises to:
capture an image of the passenger while the passenger is in the autonomous vehicle; and
determine whether the passenger is authorized by comparing the captured image of the passenger to the image of the authorized passenger.

39. The one or more machine-readable storage media of claim 37, wherein the passenger authorization policy identifies an age of the authorized passenger, and wherein to determine whether the passenger is authorized comprises to:
determine identification data of the passenger;
estimate an age of the passenger based on the identification data; and
determine whether the passenger is authorized by comparing the estimated age of the passenger to the age of the authorized passenger.

40. The one or more machine-readable storage media of claim 35, wherein to determine whether the passenger is authorized comprises to:
receive an authorization token from the user; and
verify the authorization token based on the passenger authorization policy.

41. The one or more machine-readable storage media of claim 35, wherein the plurality of instructions further cause the in-vehicle passenger authorization system to:
navigate to a destination defined in the request for taxi service in response to determining that the passenger is authorized;
receive a request from the passenger while navigating to the destination; and
determine whether to perform the request received from the passenger based on the passenger authorization policy.

42. A method for authorizing a passenger of an autonomous vehicle, the method comprising:
receiving, by an in-vehicle passenger authorization system of the autonomous vehicle, a request for a taxi service;
determining, by the in-vehicle passenger authorization system, a passenger authorization policy based on the request;
detecting, by the in-vehicle passenger authorization system, the presence of a passenger in the autonomous vehicle; and
determining, by the in-vehicle passenger authorization system, whether the passenger is authorized for the taxi service based on the passenger authorization policy and in response to detecting the presence of the passenger.

43. The method of claim 42, wherein the passenger authorization policy defines an authorized number of passengers, and wherein determining whether the passenger is authorized comprises:
determining a present number of passengers in the autonomous vehicle; and
determining whether the passenger is authorized by comparing the current number of passengers to the authorized number of passengers.

44. The method of claim 42, wherein the passenger authorization policy defines identification data of an authorized passenger, and wherein determining whether the passenger is authorized comprises:
obtaining identification data of the passenger of the autonomous vehicle; and
determining whether the passenger is authorized by comparing the identification data of the passenger to the identification data of the authorized passenger.

45. The method of claim 44, wherein the passenger authorization policy includes an image of the authorized passenger, and wherein determining whether the passenger is authorized comprises:
capturing an image of the passenger while the passenger is in the autonomous vehicle; and
determining whether the passenger is authorized by comparing the captured image of the passenger to the image of the authorized passenger.

46. The method of claim 44, wherein the passenger authorization policy identifies an age of the authorized passenger, and wherein determining whether the passenger is authorized comprises:
determining identification data of the passenger;
estimating an age of the passenger based on the identification data; and
determining whether the passenger is authorized by comparing the estimated age of the passenger to the age of the authorized passenger.

47. The method of claim 42, wherein determining whether the passenger is authorized comprises:
receiving an authorization token from the user; and
verifying the authorization token based on the passenger authorization policy.

48. The method of claim 42, further comprising:
navigating, by the autonomous vehicle, to a destination defined in the request for taxi service in response to determining that the passenger is authorized;
receiving, via a user interface of the in-vehicle passenger authorization system, a request from the passenger while navigating to the destination; and
determining, by the in-vehicle passenger authorization system, whether to perform the request received from the passenger based on the passenger authorization policy.

49. One or more machine-readable storage media comprising a plurality of instructions stored thereon that, in response to execution, cause a passenger authorization management server to:
receive a request for taxi service from a computing device of a user;
generate a passenger authorization policy based on the request for the taxi service, the passenger authorization policy comprising a set of policy rules usable by an autonomous vehicle to authorize a passenger; and
transmit by the passenger authorization management server, the request for taxi service and the passenger authorization policy to the autonomous vehicle.

50. The one or more machine-readable storage media of claim 49, wherein the plurality of instructions further cause the passenger authorization management server to:
generate an authorization token based on the request for taxi service, the authorization token usable by the user to authorize a passenger, and
transmit the authorization token to the computing device of the user.
